(19) United States
(12) Patent Application Publication
(10) Pub. No.: US 2005/0247906 A1
(43) Pub. Date: Nov. 10, 2005

(54) Heat-storage means

(76) Inventors: Mark Neuschutz, Darmstadt (DE); Ralf Glausch, Muhltal (DE); Wolfgang Voigt, Weissenborn (DE); Dawen Zeng, Freiberg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/521,018

(22) PCT Filed: Jun. 17, 2003
(86) PCT No.: PCT/EP03/06372

§ 371 Date: Jan. 12, 2005

(30) Foreign Application Priority Data
Jul. 12, 2002 (DE) 102 31 844.1

(51) Int. Cl. C09K 3/18

(52) U.S. Cl. 252/70

(57) ABSTRACT

The present invention relates to phase change materials (PCMs) for the storage of thermal energy in the form of phase change heat, and to the use thereof.

The present invention relates to phase change materials (PCMs) for the storage of thermal energy in the form of phase change heat based on ternary mixtures composed of water and two salts from the group consisting of zinc nitrate, lithium nitrate, calcium nitrate, magnesium nitrate, potassium nitrate and sodium nitrate, to the preparation thereof and to the use thereof.

Heat peaks or deficits frequently have to be avoided in industrial processes, i.e. thermostatting is necessary. To this end, use is usually made of heat exchangers. They contain heat transfer media which transport heat from one site or medium to another. In order to dissipate heat peaks, use is made, for example, of the release of the heat to the air via a heat exchanger. However, this heat is then no longer available for compensating for heat deficits. This problem is solved by the use of heat-storage systems.

Known storage media are, for example, water or rocks/concrete for storing sensible heat or phase change materials (PCMs), such as salts, salt hydrates or mixtures thereof, for storing heat in the form of heat of fusion (“latent heat”).

It is known that when a substance melts, i.e. is converted from the solid phase into the liquid phase, heat is consumed, i.e. is taken up, and is stored as latent heat so long as the liquid state still exists, and that this latent heat is liberated again on solidification, i.e. on conversion from the liquid phase into the solid phase.

The charging of a heat-storage system basically requires a higher temperature than can be achieved during discharging, since a temperature difference is necessary for the transport/flow of heat. The quality of the heat is dependent on the temperature at which it is available again: the higher the temperature, the more ways the heat can be employed. For this reason, it is desirable for the temperature level during storage to drop as little as possible.

In the case of the storage of sensible heat (for example by heating water), the input of heat is accompanied by constant heating of the storage material (and the opposite during discharging), while latent heat is stored and discharged at the melting point of the PCM. Latent-heat storage therefore has the advantage over the storage of sensible heat that the temperature loss is restricted to the loss during heat transport from and to the storage system.

As storage medium in latent-heat storage systems, use is usually made hitherto of substances which have a solid-liquid phase transition in the temperature range which is essential for the use, i.e. substances which melt during use.

Inorganic salts and in particular hydrates thereof are, as is known, substances which have the highest specific heats of fusion and are therefore favoured as latent-heat storage systems (PCMs). In addition to a suitable melting point and heat of fusion, their use in industry depends on a number of further properties, such as supercooling and stratification, which greatly restricts the application of the few PCMs known to date.

Only few PCMs for the temperature range around 25° C. are known. However, this range is very interesting for the construction sector. Paraffins and lithium nitrate trihydrate having a melting point of 29° C., potassium fluoride tetrahydrate having a melting point of 18° C. and Glauber's salt with 24° C. are known.

Paraffin is problematic in the construction sector owing to its flammability. The inorganic materials have considerable stratification (incongruent melting behaviour) and/or a considerable tendency towards supercooling.

The object was to provide cycle-stable phase change materials (PCMs) for heat storage and buffering in the temperature range around 25° C.

The present invention relates to a heat-storage medium comprising ternary mixtures composed of water and two salts from the group consisting of lithium nitrate, sodium nitrate, magnesium nitrate, potassium nitrate, calcium nitrate and zinc nitrate. The invention also relates to ternary mixtures selected from the group consisting of zinc nitrate/lithium nitrate/water, zinc nitrate/calcium nitrate/water, lithium nitrate/sodium nitrate/water and zinc nitrate/magnesium nitrate/water. The invention likewise relates to a process for the preparation of these mixtures and to the use, optionally with auxiliaries, as storage medium in latent-heat storage systems, for the thermostatting of buildings, in plaster or in or on Venetian blinds, and in air-conditioning units for motor vehicles, transport or storage facilities. Use in transparent thermal insulation systems (TTIs) is possible, but also in inside and outside walls and ceilings for increasing the “thermal mass”.

For the purposes of the present invention, the term thermostatting is taken to mean both thermal insulation and thus the maintenance of a temperature, as well as the absorption of brief temperature variations or peaks. Applications can exist both in heat storage and selective release and in absorption of heat and consequently cooling.

The heat-storage medium according to the invention is defined as a phase change material (PCM) which comprises water and two salts from the group consisting of lithium nitrate, sodium nitrate, magnesium nitrate, potassium nitrate, calcium nitrate and zinc nitrate.

The respective hydrates of these compounds can also be employed.

Particular preference is given to the systems lithium nitrate/zinc nitrate/water, lithium nitrate/sodium nitrate/water, calcium nitrate/zinc nitrate/water and magnesium nitrate/zinc nitrate/water.

It has been found that the media according to the invention have their melting points in the desired temperature range around 25° C.

Further suitable mixtures are summarised in the following table.

TABLE 1
Mixtures

| Mixture No. | Component 1 | Component 2 | Component 3 |
|---|---|---|---|
| 1 | LiNO₃ | NaNO₃ | Water |
| 2 | LiNO₃ | Mg(NO₃)₂ | Water |
| 3 | LiNO₃ | Ca(NO₃)₂ | Water |
| 4 | LiNO₃ | Zn(NO₃)₂ | Water |
| 5 | NaNO₃ | Mg(NO₃)₂ | Water |
| 6 | NaNO₃ | Ca(NO₃)₂ | Water |
| 7 | NaNO₃ | Zn(NO₃)₂ | Water |
| 8 | Mg(NO₃)₂ | Ca(NO₃)₂ | Water |
| 9 | Mg(NO₃)₂ | Zn(NO₃)₂ | Water |
| 10 | Ca(NO₃)₂ | Zn(NO₃)₂ | Water |
| 11 | LiNO₃ | LiCl | Water |
| 12 | LiNO₃ | LiClO₄ | Water |
| 13 | LiClO₄ | Ca(ClO₄)₂ | Water |
| 14 | Ca(NO₃)₂ | Ca(ClO₄)₂ | Water |
| 15 | LiCl | MgCl₂ | Water |
| 16 | LiCl | CaCl₂ | Water |
| 17 | LiCl | ZnCl₂ | Water |

The solid/liquid phase transition is determined by the composition of the mixtures.

The composition of the mixtures is in the range from 1 to 70% by weight, preferably from 7 to 58% by weight. The salts and water or hydrates thereof are melted and mixed well by vigorous stirring. A protective tube can be attached to the apparatus in order to prevent the water vapour formed from escaping. This enables the mixing ratio of the components to be kept constant.

Other suitable starting materials, such as, for example, hydroxides, oxides, carbonates, etc., can likewise be reacted with nitric acid to give the desired nitrate salts.

After cooling to below the melting point, the crystallisation can additionally be initiated by acoustic or mechanical loading.

Besides the salt mixtures, the mixtures according to the invention may also comprise nucleating agents.

In addition, the mixtures according to the invention may be micro- or macro-encapsulated, if necessary with addition of further auxiliaries.

The following examples are intended to explain the invention in greater detail, but without restricting it.

### EXAMPLES

### Example 1

NaNO₃/LiNO₃/water

228.5 g of lithium nitrate and 26.76 g of sodium nitrate are weighed into a round-necked flask with 156.45 g of deionised water and melted at about 40° C. in a heating mantle. A clear, slightly yellowish melt is obtained. The mixture has a melting point of 27.7° C.

The following mixtures are prepared analogously:

| Mixture | Component 1 | % by wt. | Component 2 | % by wt. | Component 3 | % by wt. |
|---|---|---|---|---|---|---|
| A | Zn(NO₃)₂ | 37-40 | LiNO₃ | 20-24 | H₂O | 36-43 |
| B | Zn(NO₃)₂ | 32-35 | Ca(NO₃)₂ | 31-34 | H₂O | 31-37 |
| C | LiNO₃ | 50-55 | NaNO₃ | 7-9 | H₂O | 36-43 |
| D | Zn(NO₃)₂ | 55-58 | Mg(NO₃)₂ | 7-9 | H₂O | 33-38 |
| E | Zn(NO₃)₂ | 35-38 | Mg(NO₃)₂ | 31-34 | H₂O | 28-34 |

The melting points of these mixtures are in the desired temperature range around 25° C.

| Mixture | Melting point |
|---|---|
| A | 20° C. |
| B | 23° C. |
| C | 27° C. |
| D | 32° C. |
| E | 33° C. |

### Example 2

Mg(NO₃)₂*6 H₂O/NaNO3/KNO₃

34.25 g of magnesium nitrate hexahydrate are weighed out into a round-necked flask with 3.5 g of sodium nitrate and 12.25 g of potassium nitrate. At an oil-bath temperature of 90° C., the salts are melted homogeneously with constant stirring. A clear and slightly yellowish melt is obtained. It crystallises particularly well through subsequent kneading.

The melting point of the mixture is 65° C.

1. Heat-storage medium comprising ternary mixtures composed of water and two salts from the group consisting of lithium nitrate, sodium nitrate, magnesium nitrate, potassium nitrate, calcium nitrate and zinc nitrate:

2. Heat-storage medium according to claim 1, characterised in that the proportion of the individual components in the mixtures is in the range 1-70% by weight.

3. Heat-storage medium according to claim 2, characterised in that the proportion of the individual components in the mixtures is in the range 7-58% by weight.

4. Heat-storage medium according to claim 1, characterised in that the mixtures are composed of zinc nitrate/lithium nitrate/water, zinc nitrate/calcium nitrate/water, lithium nitrate/sodium nitrate/water or zinc nitrate/magnesium nitrate/water.

5. Heat-storage medium according to claim 1, characterised in that the medium is encapsulated.

6. Process for the preparation of a medium according to claim 1, characterised in that the mixtures of two compounds selected from the group consisting of lithium nitrate, sodium nitrate, magnesium nitrate, potassium nitrate, calcium nitrate and zinc nitrate or hydrates thereof and water are melted, where the proportion of the individual components in the mixture is in the range from 10 to 90 mol %, and optionally subsequently brought to crystallisation.

7. Use of a medium according to claim 1, optionally together with auxiliaries, as storage medium in latent-heat storage systems.

8. Use of a medium according to claim 1 for the thermostatting of buildings, in plaster or in or on Venetian blinds.

9. Use of a medium according to claim 1 in air-conditioning units for motor vehicles, transport or storage facilities.

10. Use of a medium according to claim 1 in transparent thermal insulation systems.
